(19) United States
(12) Patent Application Publication
(10) Pub. No.: US 2014/0289705 A1
(43) Pub. Date: Sep. 25, 2014

(54) Systems and Methods for Generating Function-Relation Call Trees

(71) Applicant: Tencent Technology (Shenzhen) Company Limited, Shenzhen (CN)

(72) Inventor: Sixi Lu, Shenzhen (CN)

(21) Appl. No.: 14/296,526

(22) Filed: Jun. 5, 2014

Related U.S. Application Data
(63) Continuation of application No. PCT/CN2013/087380, filed on Nov. 19, 2013.

(30) Foreign Application Priority Data
Dec. 24, 2012 (CN) 201210567720.7

(51) Int. Cl. G06F 9/44

(52) U.S. Cl. CPC G06F 8/75
USPC 717/123

(57) ABSTRACT

Systems and methods are provided for generating a function-relation call tree. For example, an externally-specified global variable name is acquired; whether a first function matches the externally-specified global variable name is inquired; in response to the first function matching the externally-specified global variable name, whether a code of the first function includes a branch-judgment code is determined; in response to the code of the first function including the branch-judgment code, the code of the first function is divided to acquire a pre-branch-judgment code, a branch-judgment code and a post-branch-judgment code; the branch judgment code is analyzed to determine whether a related function is called by a code section associated with an attribute value of the branch-judgment code; and in response to the related function being called by the code section associated with the attribute value of the branch-judgment code, a function-relation call tree between the code section associated with the attribute value and the related function is generated.

### CROSS-REFERENCES TO RELATED APPLICATIONS

This application claims priority to Chinese Patent Application No. 201210567720.7, filed Dec. 24, 2012, incorporated by reference herein for all purposes.

### BACKGROUND OF THE INVENTION

The present invention is directed to computer technology. More particularly, the invention provides systems and methods for data processing. Merely by way of example, the invention has been applied to computer programs. But it would be recognized that the invention has a much broader range of applicability.

In software development, when a code of a function is changed, the effects of the code change are often assessed to determine whether the code change may cause incompatibility so as to provide a more accurate test range. In actual application, a function-relation call tree is generally used to assess the effects of the code change. That is, upon the code change, a function associated with the changed code is determined, and then the upper-level call relations and the lower-level call relations are checked for assessing one or more related functions that may be affected by the code change.

FIG. 1 is a conventional simplified diagram showing a function-relation call tree. As shown in FIG. 1, when code change is included in a code section “case ‘IE’” associated with an attribute value “IE” in Function 1, it is assessed under ideal circumstances that related functions affected by the code change include only “Function2” that has a call relation with the code section “case ‘IE’.” But the structure of the function-relation call tree as shown in FIG. 1 determines that the granularity for assessing the effects of the code change is at the function level. That is, when the code section “case ‘IE’” associated with the attribute value “IE” in Function 1 changes, it is assessed that “Function 2” and “Function 3” that have calling relations with “Function 1” are both affected.

The structure of the function-relation call tree determines that the granularity used for assessing the effects of the code change is very large, which often makes it difficult to accurately determine the effects of the code change associated with a certain attribute value in a function, and increases the burden on the system for assessing the effects of the code change.

Hence it is highly desirable to improve the techniques for assessing effects of code changes.

### BRIEF SUMMARY OF THE INVENTION

The present invention is directed to computer technology. More particularly, the invention provides systems and methods for data processing. Merely by way of example, the invention has been applied to computer programs. But it would be recognized that the invention has a much broader range of applicability.

According to one embodiment, a method is provided for generating a function-relation call tree. For example, an externally-specified global variable name is acquired; whether a first function matches the externally-specified global variable name is inquired; in response to the first function matching the externally-specified global variable name, whether a code of the first function includes a branch judgment code is determined; in response to the code of the first function including the branch judgment code, the code of the first function is divided to acquire a pre-branch-judgment code, a branch-judgment code and a post-branch-judgment code; the branch judgment code is analyzed to determine whether a related function is called by a code section associated with an attribute value of the branch judgment code; and in response to the related function being called by the code section associated with the attribute value of the branch-judgment code, a function-relation call tree between the code section associated with the attribute value and the related function is generated.

According to another embodiment, a system for generating a function-relation call tree includes an acquisition unit, an inquiry unit, a judgment unit, a splitting unit, a determination unit, and a generation unit. The acquisition unit is configured to acquire an externally-specified global variable name. The inquiry unit is configured to inquire whether a first function matches the externally-specified global variable name. The judgment unit is configured to determine whether a code of the first function includes a branch judgment code in response to the first function matching the externally-specified global variable name. The splitting unit is configured to divide the code of the first function to acquire a pre-branch-judgment code, a branch-judgment code and a post-branch-judgment code in response to the code of the first function including the branch-judgment code. The determination unit is configured to analyze the branch judgment code to determine whether a related function is called by a code section associated with an attribute value of the branch-judgment code. The generation unit is configured to generate a function-relation call tree between the code section associated with the attribute value and the related function in response to the related function being called by the code section associated with the attribute value of the branch-judgment code.

According to yet another embodiment, a non-transitory computer readable storage medium comprises programming instructions for generating a function-relation call tree. The programming instructions are configured to cause one or more data processors to execute certain operations. For example, an externally-specified global variable name is acquired; whether a first function matches the externally-specified global variable name is inquired; in response to the first function matching the externally-specified global variable name, whether a code of the first function includes a branch-judgment code is determined; in response to the code of the first function including the branch judgment code, the code of the first function is divided to acquire a pre-branch-judgment code, a branch judgment code and a post-branch-judgment code; the branch-judgment code is analyzed to determine whether a related function is called by a code section associated with an attribute value of the branch judgment code; and in response to the related function being called by the code section associated with the attribute value of the branch judgment code, a function-relation call tree between the code section associated with the attribute value and the related function is generated.

For example, the systems and methods disclosed herein are configured to generate a function-relation call tree that has a relatively small granularity for assessing effects of code changes so as to accurately determine the effects of the code changes, and reducing the system burden for assessment of the effects of the code changes.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a conventional simplified diagram showing a function-relation call tree;

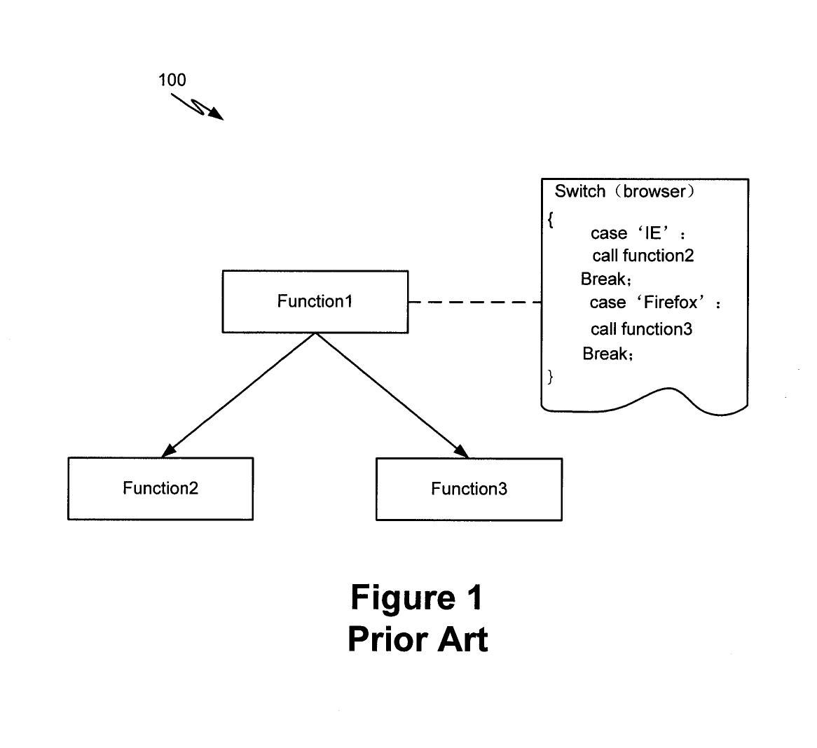

FIG. 2 is a simplified diagram showing a method for generating a function-relation call tree according to one embodiment of the present invention;

FIG. 3 is a simplified diagram showing a method for generating a function-relation call tree according to another embodiment of the present invention;

FIG. 4 is a simplified diagram showing multiple functions according to another embodiment of the present invention;

FIG. 5 is a simplified diagram showing a system for generating a function-relation call tree according to one embodiment of the present invention; and

FIG. 6 is a simplified diagram showing a system for generating a function-relation call tree according to another embodiment of the present invention.

### DETAILED DESCRIPTION OF THE INVENTION

The present invention is directed to computer technology. More particularly, the invention provides systems and methods for data processing. Merely by way of example, the invention has been applied to computer programs. But it would be recognized that the invention has a much broader range of applicability.

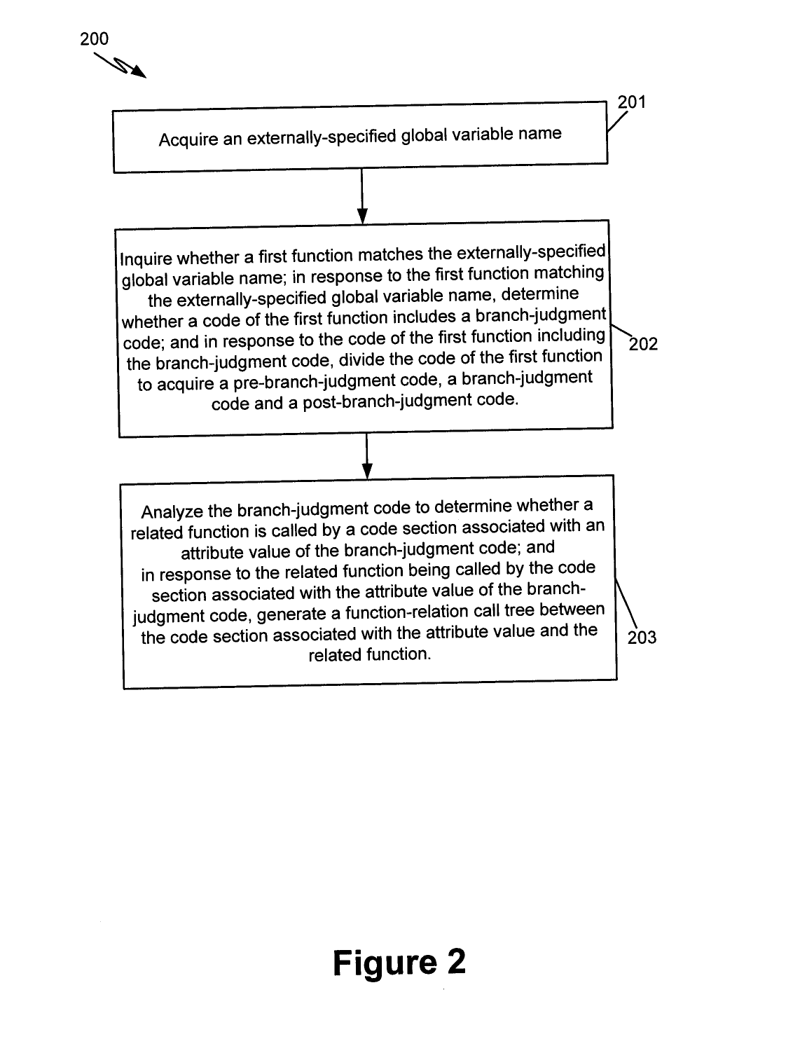

FIG. 2 is a simplified diagram showing a method for generating a function-relation call tree according to one embodiment of the present invention. This diagram is merely an example, which should not unduly limit the scope of the claims. One of ordinary skill in the art would recognize many variations, alternatives, and modifications. The method 200 includes at least the process 201 for acquiring an externally-specified global variable name, the process 202 for inquiring whether a first function matches the externally-specified global variable name, determining whether a code of the first function includes a branch-judgment code, and dividing the code of the first function to acquire a pre-branch-judgment code, a branch judgment code and a post-branch-judgment code, and the process 203 for analyzing the branch judgment code to determine whether a related function is called by a code section associated with an attribute value of the branch judgment code and generating a function-relation call tree between the code section associated with the attribute value and the related function.

According to one embodiment, during the process 201, an externally-specified global variable name is acquired. For example, the externally-specified global variable name is received (e.g., by a system). In another example, the externally-specified global variable name is actively read (e.g., by the system).

According to another embodiment, during the process 202, whether a first function matches the externally-specified global variable name is inquired. For example, in response to the first function matching the externally-specified global variable name, whether a code of the first function includes a branch judgment code is determined. As an example, in response to the code of the first function including the branch judgment code, the code of the first function is divided to acquire a pre-branch-judgment code, a branch judgment code and a post-branch-judgment code. In an example, the inquiring whether a first function matches the externally-specified global variable name includes: performing a static analysis on the code of the first function to acquire a predefined global variable name associated with the first function and determining whether the predefined global variable name associated with the first function is the same as the externally-specified global variable name. For example, in response to the predefined global variable name associated with the first function being the same as the externally-specified global variable name, the first function is determined to match the externally-specified global variable name. In another example, in response to the predefined global variable name associated with the first function being different from the externally-specified global variable name, the first function is determined not to match the externally-specified global variable name.

According to yet another embodiment, during the process 203, the branch-judgment code is analyzed to determine whether a related function is called by a code section associated with an attribute value of the branch-judgment code. For example, in response to the related function being called by the code section associated with the attribute value of the branch-judgment code, a function-relation call tree between the code section associated with the attribute value and the related function is generated.

In one embodiment, if the first function is determined to match the externally-specified global variable name during the process 202, and the code of the first function does not include the branch-judgment code, a global call tree for the entire first function is generated. For example, if it is determined during the process 203 that the related function is not called by the code section associated with the attribute value in the branch judgment code, the global call tree for the entire first function is generated.

In some embodiments, the method 200 further includes the process for generating a global function-relation call tree for the entire first function based on at least information associated with merging the function-relation call tree between the code section associated with the attribute value and the related function. In certain embodiments, the method 200 further includes the process for predefining one or more global variable names and a set of attribute values and reading the predefined one or more global variable names and one or more attribute values from the set of attribute values into the first function. As an example, the process for predefining one or more global variable names and a set of attribute values and reading the predefined one or more global variable names and one or more attribute values from the set of attribute values into the first function is executed before the process for acquiring the externally-specified global variable name.

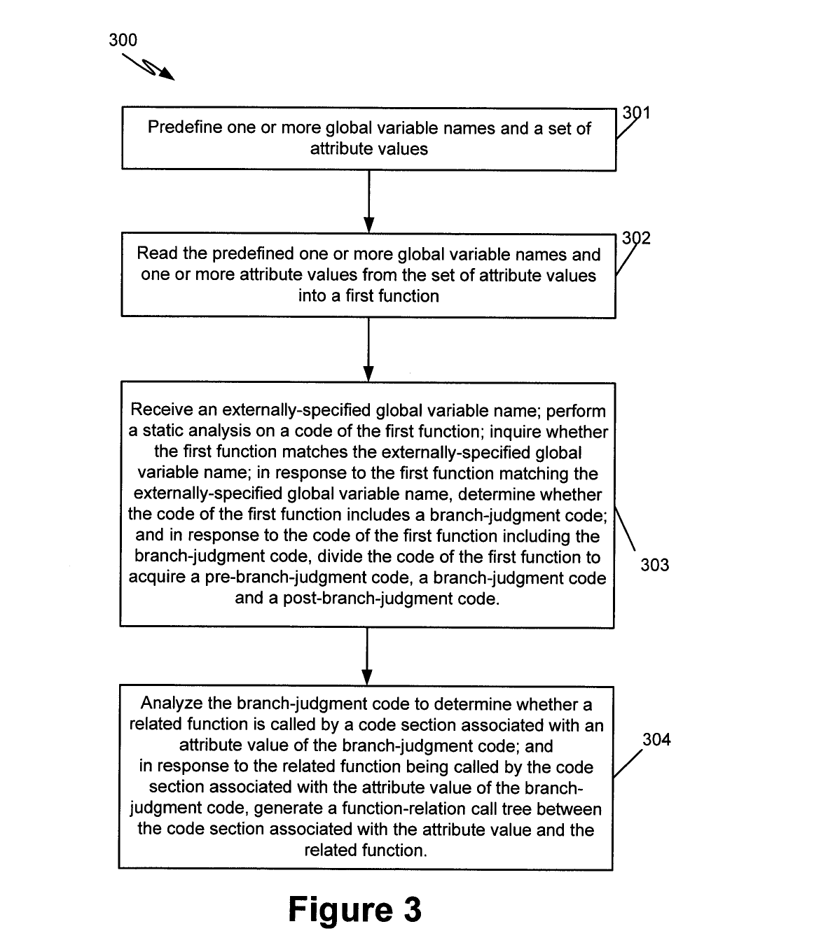

FIG. 3 is a simplified diagram showing a method for generating a function-relation call tree according to another embodiment of the present invention. This diagram is merely an example, which should not unduly limit the scope of the claims. One of ordinary skill in the art would recognize many variations, alternatives, and modifications. The method 300 includes at least the process 301 for predefining one or more global variable names and a set of attribute values, the process 302 for reading the predefined one or more global variable names and one or more attribute values from the set of attribute values into a first function, the process 303 for receiving an externally-specified global variable name, performing a static analysis on a code of the first function, inquiring whether the first function matches the externally-specified global variable name, determining whether the code of the first function includes a branch judgment code, and dividing the code of the first function to acquire a pre-branch-judgment code, a branch judgment code and a post-branch-judgment code, and the process 304 for analyzing the branch-judgment code to determine whether a related function is called by a code section associated with an attribute value of the branch-judgment code and generating a function-relation call tree between the code section associated with the attribute value and the related function.

According to one embodiment, during the process 301, one or more global variable names and a set of attribute values are predefined. For example, the predefined global variable names and the predefined set of attribute values are used in the first function. As an example, a predefined global variable name is “string gBrowser.” In another example, a predefined set of attribute values is {“IE”, “Chrome”, “Firefox”}. The predefined global variable names are placed in a file associated with the first function, for example, a header file of C/C++, in some embodiments.

According to another embodiment, during the process 302, the predefined one or more global variable names and one or more attribute values are read from the set of attribute values into a first function. For example, a morphology and grammar analyzer is used to read the predefined global variable names and one or more attribute values in the predefined set of attribute values into the first function.

According to yet another embodiment, during the process 303, an externally-specified global variable name is received, and a static analysis is performed on a code of the first function. For example, whether the first function matches the externally-specified global variable name is inquired. In another example, in response to the first function matching the externally-specified global variable name, whether the code of the first function includes a branch-judgment code is determined. As an example, in response to the code of the first function including the branch-judgment code, the code of the first function is divided to acquire a pre-branch-judgment code, a branch-judgment code and a post-branch-judgment code.

In one embodiment, during the process 304, the branch-judgment code is analyzed to determine whether a related function is called by a code section associated with an attribute value of the branch judgment code. For example, in response to the related function being called by the code section associated with the attribute value of the branch judgment code, a function-relation call tree between the code section associated with the attribute value and the related function is generated.

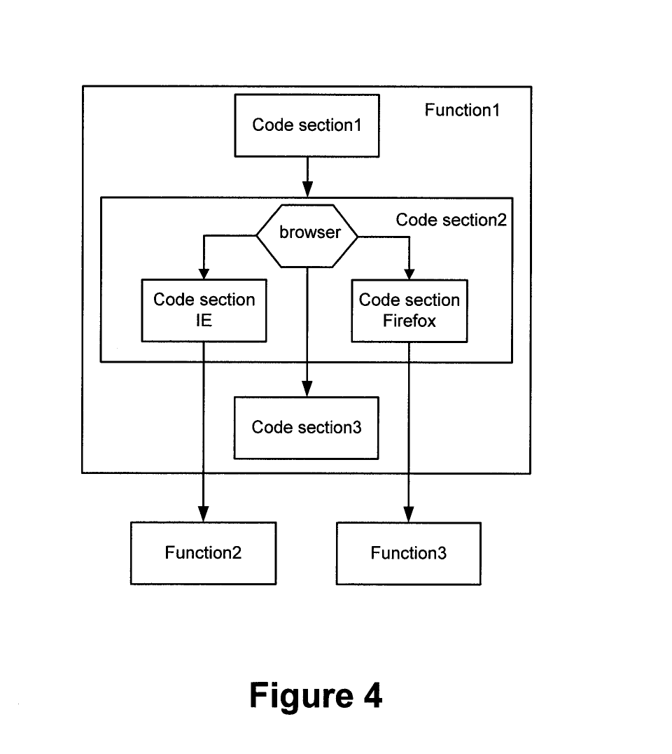

FIG. 4 is a simplified diagram showing multiple functions according to another embodiment of the present invention. This diagram is merely an example, which should not unduly limit the scope of the claims. One of ordinary skill in the art would recognize many variations, alternatives, and modifications.

As shown in FIG. 4, it is determined (e.g., during the process 303 as shown in FIG. 3) that a function “Function1” matches an externally-specified global variable name and the code of “Function1” includes a branch-judgment code, in some embodiments. For example, the code of “Function1” are divided into a pre-branch-judgment code (“code section 1”), a branch-judgment code (“code section 2”) and a post-branch-judgment code (“code section 3”). As an example, further analyses are performed on the branch-judgment code (“code section 2”), and it is determined that two related functions “Function2” and “Function3” are called by code sections with different attribute values “IE” and “Firefox” in the branch judgment code (“code section 2”) respectively. In another example, a function-relation call tree between the code section associated with the attribute value “IE” and the related “Function2” is generated, and a function-relation call tree between the code section associated with the attribute value “Firefox” and the related “Function3” is generated.

In certain embodiments, if changes are made to the code section associated with the attribute value “IE,” the effects of the code change are assessed to be on “Function2” and only the branch from “Function1” to “Function1” needs to be verified. On the other hand, if changes are made to the code section associated with the attribute value “Firefox,” the effects of the code change are assessed to be on “Function3” and only the branch from “Function1” to “Function3” needs to be verified. In some embodiments, if changes are made to both the code section associated with the attribute value “IE” and the code section associated with the attribute value “Firefox,” the effects of the code change are assessed to be on “Function2” and “Function3.” For example, the branch from “Function1” to “Function2” and the branch from “Function1” to “Function3” need to be verified. As an example, a function-relation call tree is generated using flex, bison and/or graphviz.

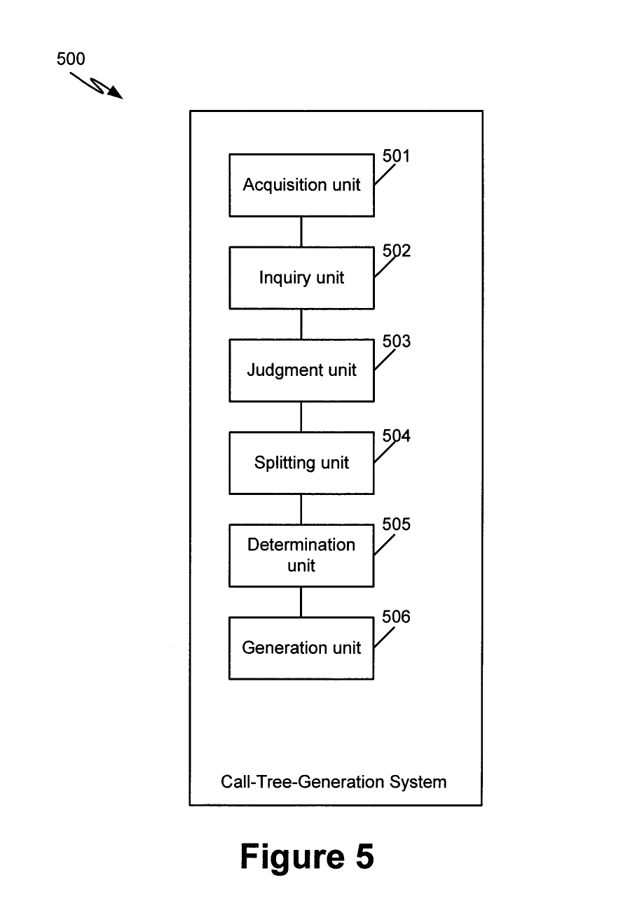

FIG. 5 is a simplified diagram showing a system for generating a function-relation call tree according to one embodiment of the present invention. This diagram is merely an example, which should not unduly limit the scope of the claims. One of ordinary skill in the art would recognize many variations, alternatives, and modifications. The system 500 includes an acquisition unit 501, an inquiry unit 502, a judgment unit 503, a splitting unit 504, a determination unit 505, and a generation unit 506.

According to one embodiment, the acquisition unit 501 is configured to acquire an externally-specified global variable name. For example, the inquiry unit 502 is configured to inquire whether a first function matches the externally-specified global variable name. As an example, the judgment unit 503 is configured to determine whether a code of the first function includes a branch-judgment code in response to the first function matching the externally-specified global variable name. In another example, the splitting unit 504 is configured to divide the code of the first function to acquire a pre-branch-judgment code, a branch judgment code and a post-branch-judgment code in response to the code of the first function including the branch judgment code. In yet another example, the determination unit 505 is configured to analyze the branch-judgment code to determine whether a related function is called by a code section associated with an attribute value of the branch judgment code. For example, the generation unit 506 is configured to generate a function-relation call tree between the code section associated with the attribute value and the related function in response to the related function being called by the code section associated with the attribute value of the branch judgment code.

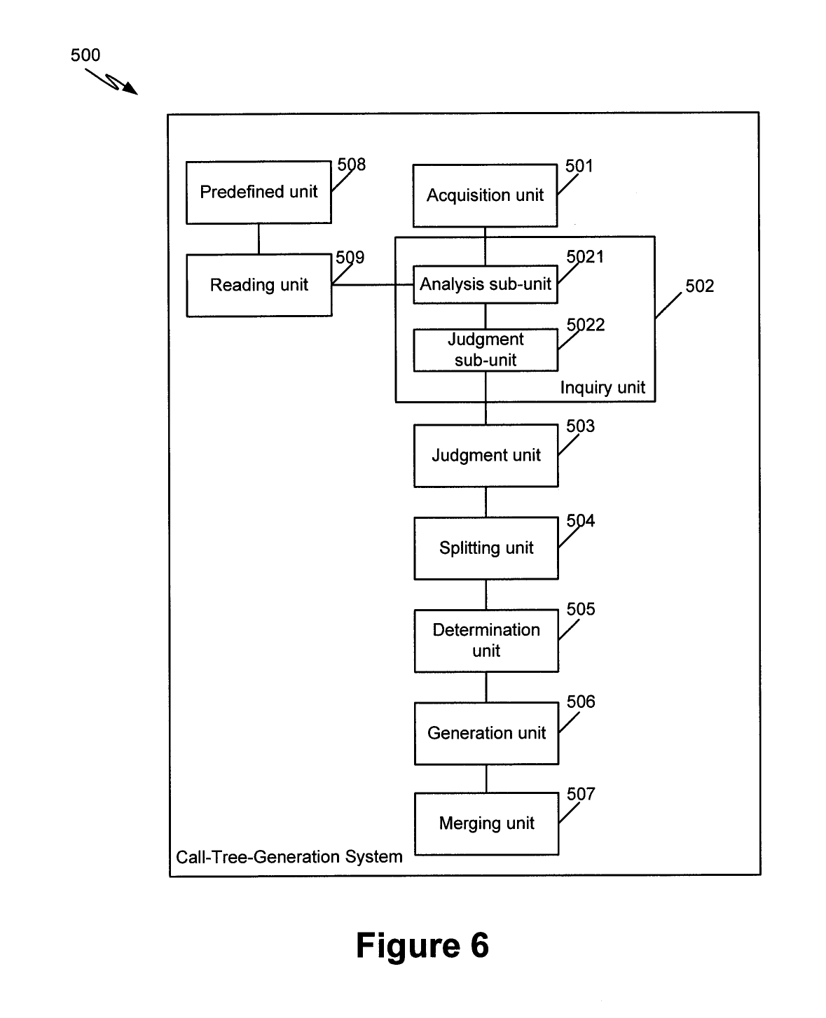

FIG. 6 is a simplified diagram showing the system 500 for generating a function-relation call tree according to another embodiment of the present invention. This diagram is merely an example, which should not unduly limit the scope of the claims. One of ordinary skill in the art would recognize many variations, alternatives, and modifications. The system 500 further includes a merging unit 507, a predefined unit 508, and a reading unit 509. For example, the inquiry unit 502 includes an analysis sub-unit 5021 and a judgment sub-unit 5022.

According to one embodiment, the analysis sub-unit 5021 is configured to perform a static analysis on the code of the first function to acquire a predefined global variable name associated with the first function. For example, the judgment sub-unit 5022 is configured to determine whether the predefined global variable name associated with the first function is the same as the externally-specified global variable name. In another example, the judgment sub-unit 5022 is further configured to: in response to the predefined global variable name associated with the first function being the same as the externally-specified global variable name, determine that the first function matches the externally-specified global variable name, and in response to the predefined global variable name associated with the first function being different from the externally-specified global variable name, determine that the first function does not match the externally-specified global variable name.

According to another embodiment, the merging unit is configured to generate a global function-relation call tree based on at least information associated with merging the function-relation call tree between the code section associated with the attribute value and the related function. For example, the predefined unit 508 is configured to predefine one or more global variable names and a set of attribute values. As an example, the reading unit 509 is configured to read the predefined one or more global variable names and one or more attribute values from the set of attribute values into the first function.

According to yet another embodiment, a method is provided for generating a function-relation call tree. For example, an externally-specified global variable name is acquired; whether a first function matches the externally-specified global variable name is inquired; in response to the first function matching the externally-specified global variable name, whether a code of the first function includes a branch judgment code is determined; in response to the code of the first function including the branch-judgment code, the code of the first function is divided to acquire a pre-branch-judgment code, a branch judgment code and a post-branch-judgment code; the branch judgment code is analyzed to determine whether a related function is called by a code section associated with an attribute value of the branch judgment code; and in response to the related function being called by the code section associated with the attribute value of the branch-judgment code, a function-relation call tree between the code section associated with the attribute value and the related function is generated. For example, the method is implemented according to at least FIG. 2, and/or FIG. 3.

According to another embodiment, a system for generating a function-relation call tree includes an acquisition unit, an inquiry unit, a judgment unit, a splitting unit, a determination unit, and a generation unit. The acquisition unit is configured to acquire an externally-specified global variable name. The inquiry unit is configured to inquire whether a first function matches the externally-specified global variable name. The judgment unit is configured to determine whether a code of the first function includes a branch-judgment code in response to the first function matching the externally-specified global variable name. The splitting unit is configured to divide the code of the first function to acquire a pre-branch-judgment code, a branch judgment code and a post-branch-judgment code in response to the code of the first function including the branch-judgment code. The determination unit is configured to analyze the branch judgment code to determine whether a related function is called by a code section associated with an attribute value of the branch-judgment code. The generation unit is configured to generate a function-relation call tree between the code section associated with the attribute value and the related function in response to the related function being called by the code section associated with the attribute value of the branch-judgment code. For example, the system is implemented according to at least FIG. 5, and/or FIG. 6.

According to yet another embodiment, a non-transitory computer readable storage medium comprises programming instructions for generating a function-relation call tree. The programming instructions are configured to cause one or more data processors to execute certain operations. For example, an externally-specified global variable name is acquired; whether a first function matches the externally-specified global variable name is inquired; in response to the first function matching the externally-specified global variable name, whether a code of the first function includes a branch-judgment code is determined; in response to the code of the first function including the branch judgment code, the code of the first function is divided to acquire a pre-branch-judgment code, a branch-judgment code and a post-branch-judgment code; the branch-judgment code is analyzed to determine whether a related function is called by a code section associated with an attribute value of the branch-judgment code; and in response to the related function being called by the code section associated with the attribute value of the branch judgment code, a function-relation call tree between the code section associated with the attribute value and the related function is generated. For example, the storage medium is implemented according to at least FIG. 2, and/or FIG. 3.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for generating a function-relation call tree, the method comprising:
acquiring an externally-specified global variable name;
inquiring whether a first function matches the externally-specified global variable name;
in response to the first function matching the externally-specified global variable name, determining whether a code of the first function includes a branch-judgment code;
in response to the code of the first function including the branch judgment code, dividing the code of the first function to acquire a pre-branch-judgment code, a branch-judgment code and a post-branch-judgment code;
analyzing the branch-judgment code to determine whether a related function is called by a code section associated with an attribute value of the branch-judgment code; and
in response to the related function being called by the code section associated with the attribute value of the branch-judgment code, generating a function-relation call tree between the code section associated with the attribute value and the related function.

2. The method of claim 1 wherein the inquiring whether the first function matches the externally-specified global variable name includes:
performing a static analysis on the code of the first function to acquire a predefined global variable name associated with the first function; and
determining whether the predefined global variable name associated with the first function is the same as the externally-specified global variable name;
wherein:
in response to the predefined global variable name associated with the first function being the same as the externally-specified global variable name, the first function is determined to match the externally-specified global variable name; and
in response to the predefined global variable name associated with the first function being different from the externally-specified global variable name, the first function is determined not to match the externally-specified global variable name.

3. The method of claim 1, further comprising:
generating a global function-relation call tree based on at least information associated with merging the function-relation call tree between the code section associated with the attribute value and the related function.

4. The method of claim 3, further comprising:
predefining one or more global variable names and a set of attribute values; and
reading the predefined one or more global variable names and one or more attribute values from the set of attribute values into the first function.

5. A system for generating a function-relation call tree, the system comprising:
an acquisition unit configured to acquire an externally-specified global variable name;
an inquiry unit configured to inquire whether a first function matches the externally-specified global variable name;
a judgment unit configured to determine whether a code of the first function includes a branch judgment code in response to the first function matching the externally-specified global variable name;
a splitting unit configured to divide the code of the first function to acquire a pre-branch-judgment code, a branch judgment code and a post-branch-judgment code in response to the code of the first function including the branch-judgment code;
a determination unit configured to analyze the branch judgment code to determine whether a related function is called by a code section associated with an attribute value of the branch-judgment code; and
a generation unit configured to generate a function-relation call tree between the code section associated with the attribute value and the related function in response to the related function being called by the code section associated with the attribute value of the branch-judgment code.

6. The system of claim 5 wherein the inquiry unit includes:
an analysis sub-unit configured to perform a static analysis on the code of the first function to acquire a predefined global variable name associated with the first function; and
a judgment sub-unit configured to determine whether the predefined global variable name associated with the first function is the same as the externally-specified global variable name;
wherein the judgment sub-unit is further configured to:
in response to the predefined global variable name associated with the first function being the same as the externally-specified global variable name, determine that the first function matches the externally-specified global variable name; and
in response to the predefined global variable name associated with the first function being different from the externally-specified global variable name, determine that the first function does not match the externally-specified global variable name.

7. The system of claim 5, further comprising:
a merging unit configured to generate a global function-relation call tree based on at least information associated with merging the function-relation call tree between the code section associated with the attribute value and the related function.

8. The system of claim 7, further comprising:
a predefined unit configured to predefine one or more global variable names and a set of attribute values; and.
a reading unit configured to read the predefined one or more global variable names and one or more attribute values from the set of attribute values into the first function.

9. The system of claim 5, further comprising:
one or more data processors; and
a computer-readable storage medium;
wherein one or more of the acquisition unit, the inquiry unit, the judgment unit, the splitting unit, the determination unit, and the generation unit are stored in the storage medium and configured to be executed by the one or more data processors.

10. A non-transitory computer readable storage medium comprising programming instructions for generating a function-relation call tree, the programming instructions configured to cause one or more data processors to execute operations comprising:
acquiring an externally-specified global variable name;
inquiring whether a first function matches the externally-specified global variable name;
in response to the first function matching the externally-specified global variable name, determining whether a code of the first function includes a branch-judgment code;
in response to the code of the first function including the branch judgment code, dividing the code of the first function to acquire a pre-branch-judgment code, a branch-judgment code and a post-branch-judgment code;
analyzing the branch judgment code to determine whether a related function is called by a code section associated with an attribute value of the branch judgment code; and
in response to the related function being called by the code section associated with the attribute value of the branch judgment code, generating a function-relation call tree between the code section associated with the attribute value and the related function.

11. The method of claim 2, further comprising:
generating a global function-relation call tree based on at least information associated with merging the function-relation call tree between the code section associated with the attribute value and the related function.

12. The system of claim 6, further comprising:
a merging unit configured to generate a global function-relation call tree based on at least information associated with merging the function-relation call tree between the code section associated with the attribute value and the related function.
